(19) United States
(12) Patent Application Publication
(10) Pub. No.: US 2012/0017500 A1
(43) Pub. Date: Jan. 26, 2012

(54) Indoor Plant Duster and Solution Applicator

(76) Inventors: Russell Shane Davis, Encino, CA (US); Melissa Corkern Davis, Encino, CA (US)

(21) Appl. No.: 13/180,745

(22) Filed: Jul. 12, 2011

Related U.S. Application Data
(60) Provisional application No. 61/365,841, filed on Jul. 20, 2010.

(51) Int. Cl. A01G 1/00

(52) U.S. Cl. 47/1.5

(57) ABSTRACT

A device for cleaning and applying solution to the leaves of a plant. The device comprises a pair of tongs equipped with permanent sponge pads along the inner portion of each tong leg. A plurality of sleeve hooks is provided along each leg to allow securement of replaceable quilted sleeves, which cover the legs of the tongs while in use. The tongs are used to grasp an elongated leaf and run along its length to clean and remove dust from them using a dry sleeve. Alternatively, the sleeves may be used when wet, either with water or in conjunction with a desired solution. The wet sleeves are then used to apply the solution to specific leaves in a controlled operation, without risk of spreading or misting solution onto undesirable locations.

### CROSS REFERENCE TO RELATED APPLICATION

This application claims the benefit of U.S. Provisional Application No. 61/365,841 filed on Jul. 20, 2010, entitled “Indoor Plant Duster & Solution Applicator.”

### BACKGROUND OF THE INVENTION

1. Field of the Invention

The present invention relates to a dusting and solution applicator device specifically designed for use with indoor plants and the elongated leaves thereof.

Many indoor plants collect dust and dirt that may settle and quickly build up on leaves. This may cause plants to develop unsightly appearances and may also prevent adequate photosynthesis, thus affecting the health of the plant. Debris on leaves prevents plants from absorbing adequate sunlight and reduces the amount of carbon dioxide inhaled and oxygen emitted by the plant. The quality of indoor air surrounding the plants can decline as a result, reducing protection against indoor air pollutants caused by mold, pesticides, and other products.

In other instances, a solution or treatment must be applied to specific leaves of a plant, without spreading or wasting the solution on the surrounding areas. While some sprays can be directed, can still result in excess splash or spill over on neighboring plants and indoor regions.

An effective solution that combines plant cleaning and solution application is not available in the prior art. The present invention provides such a device, and one that utilizes removable, replaceable sleeves and can operate using a dry or wet applicator means. The present invention fulfills an unmet need in the art for such a device.

### DESCRIPTION OF THE PRIOR ART

There are several issued patents related to dusting and cleaning devices, most of which are directed toward the cleaning of Venetian blinds. These prior art devices, while acceptable for cleaning Venetian blinds, are not suitable for use with fragile plants and leaves.

Several inventions in the prior art describe devices for use with Venetian blinds. Harris U.S. Pat. No. 2,723,412 is directed to a cleaning device that may be utilized for various types of cleaning operations. The cleaning device being composed of two independent sections which when used as an assembly are particularly suitable for cleaning slats, such as Venetian blind slats, and when used independently, are particularly suitable for cleaning flat surface areas, such as windows, windshields and the like. Similarly, Schoenfield U.S. Pat. No. 2,896,243 is directed to a device by which the slats of a Venetian blind are cleaned quickly and thoroughly without dismounting the blind from its support at a window.

Also, Warner U.S. Pat. No. 3,075,223 is directed to an appliance for domestic or similar use, and suitable for cleaning the surfaces of relatively thin flexible articles, particularly Venetian blinds. Further, Warner U.S. Pat. No. 3,445,880 is directed to a Venetian blind cleaning tool comprising a U-shaped unitary member of which the ends carry cleaning members shaped to fit the slats that are resiliently biased away from each other. A releasable catch retains the cleaning elements in contact with the blind slat when in use. Finally, Bilbrey U.S. Design Pat. No. D293,980 is directed to an ornamental design for a mini blind cleaner.

The inventions mentioned above are directed primarily toward the cleaning and maintenance of Venetian blinds. However, these devices are not designed for use with fragile houseplants. Further, they do not include replaceable quilted sleeves, which are necessary to spread different aqueous solutions onto the leaves of a plant. One type of fertilizer or solution may have a negative impact on some plants, while having a positive impact on other, thus necessitating a replaceable leaf contact area. Further, replaceable sleeves allow the user the convenience of not having to clean the main portion of the device after usage.

Other devices are directed toward the cleaning of other objects. Schlechter U.S. Pat. No. 2,908,923 is directed to a cleaning device for lenses of eyeglasses and the like which is durable and provides significant cleaning action. Similarly, Murray U.S. Design Pat. No D328,373 is directed to an ornamental design for a ceiling fan duster. The Schlechter and Murray devices are useful for their intended uses, but do not contain the necessary aspects to clean and apply solutions to plants. These inventions lack replaceable quilted cleaning sleeves, and are not intended to apply solutions.

Another invention is directed to a plant solution applicator. Moore U.S. Pat. No. 4,716,677 is directed to a hand-held chemical applicator for applying chemicals such as herbicide to selected plants while shielding surrounding plants from accidental contact. The chemical is forcefully applied by ripping or pressing a selected portion of the plant against an applicator pad containing the chemical. The amount of applied chemical is controlled by variation of the pressure or area of contact between the plant and the pad. Preferably, pair of pads is mounted to the opposing surfaces of the distal portions of pincers or tongs to define an application zone between the pads. Absorbent pads are used for applying liquid chemicals and chemicals from a pad are applied with the aid of an absorbent pad carrying a solvent. The hand-held applicators are also useful for cleaning artificial plants. The Moore device does not make use of replaceable sleeves, thus would require a thorough cleaning between applications of different solutions. Further, the Moore invention is not designed to both removing debris from leaves and applying a solution thereto, nor is the cleaning of real plants and leaves contemplated. The present invention provides a device that addresses both of these issues.

Currently, there is a need in the art for a device that allows easy cleaning of plant leaves as well as application of a variety of solutions with ease, particularly one that is easily cleaned between uses and can accommodate different solutions for consecutive plants. Its structure and intent substantially diverges in design elements from the prior art and consequently it is clear that there is a need for an improvement to existing plant cleaning device now present in the art. In this regard the instant invention substantially fulfills these needs.

### SUMMARY OF THE INVENTION

In view of the foregoing disadvantages inherent in the known types of plant dusters and cleaners now present in the prior art, the present invention provides a new cleaning device wherein the same can be utilized for providing convenience for the user when cleaning debris from or applying solution to indoor plant leaves.

The present invention is designed to easily remove dirt, dust, and other types of debris from the leaves of indoor plants. The device features a tong-like structure that contains spongy padding on the inside surfaces of the tong working ends. Quilted or moistened sleeves are slid over the tong working ends for removal of debris or application of solution to a plant leaf. The user places the tongs around individual leaves and gently squeezes the leaf between the tongs of the device while running it over the entirety of the leaf length. The sleeves pick up excess dirt and debris throughout this process, or likewise spread the liquid solution along the surface of the leaf, making the leaves clean and polished.

A solution may be applied to the sleeves if desired. When the device is rubbed on the plant leaves it will simultaneously clean the leaves and apply the solution. The replaceable quilted sleeves allow different treatments to be applied to different plants without risk of cross over or wide distribution of cleaning solution through a spray applicator. This is critical when certain plants require treatment for a disease or condition, as such treatments may be harmful to surrounding plants. Overspray may also be avoided, which can stick to walls or moisten the area surrounding the plant. The ability to selectively apply a solution is an integral part of the present invention. The solution may be for the plant health, a pesticide or simply a mild cleaner or glosser for improving the shine of each leaf.

It is therefore an object of the present invention to provide a device utilizing replaceable quilted sleeves for the cleaning of plants leaves, particularly those which are elongated and narrow.

Another object of the present invention is to provide a device that allows easy and specific application of any solution to plants leaves. Another aspect of the present invention is to provide for the use of replaceable sleeves, allowing different solutions to be used without intermittent cleaning of the device itself.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself, and manner in which it may be made and used, may be better understood by referring to the following description taken in connection with the accompanying drawings.

FIG. 1 is a perspective view of the present invention, along with a close-up of the sleeve hooks for securely attaching the replaceable quilted cleaning sleeves.

FIG. 2 is a perspective view of the present invention in use, equipped with replaceable sleeves, along with the motion for removing debris from a leaf.

### DETAILED DESCRIPTION OF THE INVENTION

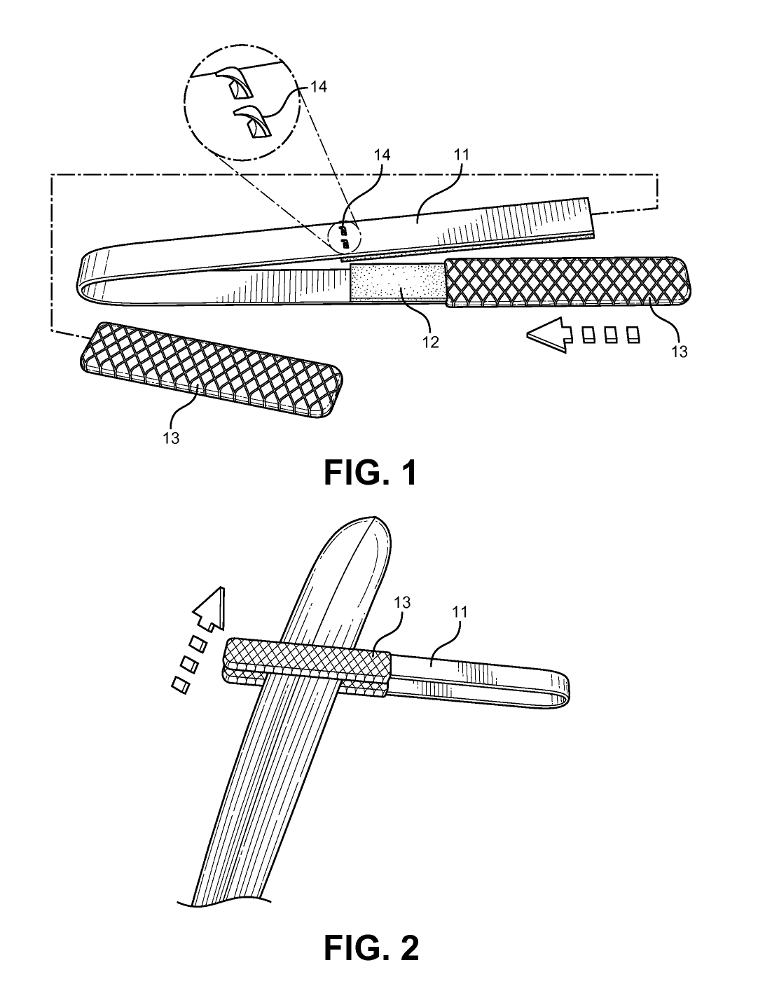

Referring now to FIG. 1, there is shown a perspective view of the present invention, with a close-up of the sleeve hooks for attaching the replaceable, quilted sleeves. The device of the present invention comprises a set of tongs 11, attached together at a single terminus. Each leg of the tongs 11 is equipped with an interior permanent pad 12 on the inner surface. A replaceable sleeve 13 may be pulled over each leg of the tongs 11 and affixed in place using one or more sleeve hooks 14 on the outer side of the leg of the tongs 11. The sleeve hooks 14 are pointed projections that grasp the inner surface of the sleeves 13 to prevent their movement along the length of the tongs. If the sleeve 13 is pulled from the tong 11 working end during use, the hooks grasp the interior of the sleeve 13 and resist movement. The interior pads 12 of the tongs 11 provide a cushion for the leaves, and allow the sleeves 13 and tongs 11 to be compressed against the leaves without causing damage or overly constraining the leaf during use. Although the leaf is grasped by the compressed tongs 11, the pad 12 allows the leaf to slide therebetween to prevent the user from forcibly pulling the leaf from its attachment to the plant.

Referring now to FIG. 2, there is shown a perspective view of the present invention in a working position, grasping the leaf of a plant and sliding the working end of the tongs 11 along the leaf upper and lower surfaces. The leaf is being compressed between the pads 12 and sleeves 13 of the tongs 11. As the tongs 11 are slid along the leaf length, dirt and debris are collected on the sleeves 13 for removal. Alternatively, moistened sleeves 13 may be applying a layer of desired solution to the leaf surface for an intended purpose.

The present invention aids in the cleaning of indoor plant leaves to both improve air quality and the health of the plant. The invention comprises a pair of thin tongs 11, which may employ an equal width structure from its working end through its handle region. The handle region is considered anywhere along the length of the tongs below the working end, which begins at the sleeve hooks and where the sleeves are applied. A user may grasp this region and compress the two handles together during use, wherein the users opens and closes a separation angle between tongs. On the underside of each arm of the tong, starting at the open terminus may be a thin, elastic pad 12. When the tongs 11 are closed, the top and bottom tong working ends meet flushly together. Disposable, quilted sleeves 13 can slide over each tong, covering the elastic pads 12. The replaceable sleeves 13 may be secured into place by hooking into one or more sleeve hooks 14 located on the outside surface of each arm.

The sleeves may comprise any material suitable for cleaning a surface without undo friction, abrasion or residue. Further, the sleeves may be any material that is adept at absorbing moisture for a period of time, and one that is elastic and compressible for the release of the same. The sleeves are disposable and ideally suited for a cotton or fabric material that can utilize static cling as a means for attaching debris and dust while in use. Also contemplated for material is sponge material and microfiber.

In use, a practitioner equips the tongs 11 with replaceable cleaning sleeves 13, securing them to the sleeve hooks 14. The sleeves 13 cover the interior tong pads 12 and provide a medium for cleaning and applying solution along the length of a plant leaf. To clean the leaf and remove dust and debris, no solution or moistening of the sleeves is necessary. The tongs 11 may be gently clasped around a leaf, such that the sleeves 13 are straddling a section of the leaf. Slight closing pressure may then be applied to the tongs 11, which closes the gap between the working end of the tongs 11 and the sleeves 14 thereon The tongs 11 can then be slid up or down the leave to remove dust and debris. This process may be repeated as needed. For solution application, the practitioner simply attaches the sleeves 13 to the tongs 11 expose the sleeves to the desired solution, either through spray application or dipping the sleeves into a vat of solution. Alternatively, pre-moistened sleeves may be applied to the tongs prior to use. The tongs 11 are then clasped around the desired leaf as with use with the dry sleeves, and slid up and down the leaf after compressing the tongs thereon to apply the solution. The sleeves 13 may be discarded after use or saved for later reuse if desired.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A hand operated assembly for cleaning debris from or applying solutions to a plant leaf, comprising:
a tong structure comprising two tong legs connected at a base terminus and providing an open end for clasping objects between said tong leg working ends;
compressible pads affixed to the inner surface of both tong working ends;
one or more sleeve hooks on the outer surface of both said tong working ends;
replaceable cleaning sleeves adapted to slide over each of said tong working ends and said elastic pads;
said cleaning sleeves affixable to said sleeve hooks to prevent sliding movement.

2) A method of apply an aqueous solution to specific plant leaves, comprising:
sliding a pair of replaceable cleaning pads over a pair of tong working ends and attaching said pads using tong sleeve hooks,
clasping a plant leaf between the replaceable tong working ends;
cleaning debris from or applying said solution to said leaf by gently sliding said clasped working ends along said leaf length.
